(19) United States
(12) Patent Application Publication
(10) Pub. No.: US 2024/0327763 A1
(43) Pub. Date: Oct. 3, 2024

(54) Premium Vodka Having Improved Smoothness

(71) Applicants: Frank George Mihalopoulos, Los Angeles, CA (US); Michael Zachary Camello, Los Angeles, CA (US); Brandon Phillip Cohen, Los Angeles, CA (US)

(72) Inventors: Frank George Mihalopoulos, Los Angeles, CA (US); Michael Zachary Camello, Los Angeles, CA (US); Brandon Phillip Cohen, Los Angeles, CA (US)

(21) Appl. No.: 18/620,959

(22) Filed: Mar. 28, 2024

Related U.S. Application Data
(60) Provisional application No. 63/455,362, filed on Mar. 29, 2023.

(51) Int. Cl. C12G 3/04

(52) U.S. Cl. CPC C12G 3/04

(57) ABSTRACT

A premium vodka having improved mouthfeel and smoothness is provided. In one aspect, the vodka is distilled from curated grains with a select variety of carefully selected olives and Extra Virgin Olive Oil. An objective of using the olives is to enhance the mouthfeel and overall product smoothness. Note the resulting premium vodka is not an olive flavored vodka.

### BACKGROUND

Curated premium liquors have become very popular, as consumers enjoy more options and greater sophistication than ever before. Widely distributed online reviews and ratings, access to greater disposable income, and an evolving appreciation for luxury lifestyles have combined to create a halcyon lifecycle for producers and consumers alike.

There remains, however, a long felt but unmet need for premium liquors distilled in new and creative ways that significantly improve the state of the prior art and help justify relative price differentials, which can be significant, between truly premium liquors and lesser brands that trade on either a legacy reputation or market momentum despite a similar or even inferior product offering.

### SUMMARY

In one example, a premium vodka having improved mouthfeel and smoothness is disclosed. In one embodiment, the vodka is distilled from curated grains with a select variety of carefully selected olives and Extra Virgin Olive Oil.

As stated, the primary reason for using the olives is to enhance the mouthfeel and overall product smoothness. Note the resulting premium vodka is no/an olive flavored vodka.

During the research and development phase, many olives and Extra Virgin Olive Oil from various parts of the world were tested to determine relative efficacy. The research was based on the hypothesis that certain ingredients present in olives (often in parts per billion or even parts per trillion) would, when added to a mixture of water and rectified ethyl alcohol, enhance the mouthfeel and smoothness of the mixture.

To test the hypothesis, various blends were developed and then bench distilled to neutral 95% alcohol. In other embodiments, samples were cut to 40% alcohol (in other words, a mixture of 95% and distilled water). For example, vodka at 40% alcohol, is known to impart a thin mouthfeel and/or an alcohol burn toward the back of the throat.

For subjective group testing, a panel of vodka drinkers were used to conduct to sensory analyses of the various prototype samples.

As a result, particular variety of olives and Extra Virgin Olive Oil were determined to be the most effective, and a detailed distillation process was developed in order to remove all undesirable volatile constituents present in the heads and tails of the distillate.

In one embodiment, during the distillation process, a sensory descriptor was developed in order to determine and properly separate the distillation cuts (e.g., the heads, hearts and tails, respectively), and to ensure product consistency. The sensory attributes are subtle, and, in general, only a trained sensory expert such as a master distiller will be capable of making the proper distinctions.

By applying the unique material sciences and compositions disclosed herein, a unique process of selecting and preparing the olives and Extra Virgin Olive Oil is achieved. In one embodiment, the selected olives and Extra Virgin Olive Oil, are blended with 96% alcohol by volume (ABV) neutral grain spirit to achieve a specified mixture, which is then filtered to remove all extraneous matter and distilled to a neutral spirit comprising a 95%- 96% ABV. The resulting ingredient, when blended with other neutral grain spirits or alcoholic beverages, has the synergistic effect of enhancing the mouthfeel and smoothness of the finished beverage.

This phenomenon is determined by a comparative sensory analysis of the vodka made in accord with the processes disclosed herein versus vodkas not distilled is such fashion. The components in the pure olive base are responsible for the synergistic effect, and are present at parts per billion and even parts per trillion dilution levels. Analysis applying gas chromatography mass spectrometry is directionally indicative that it is indeed the case.

From the foregoing, it will be understood by persons skilled in the art that while the description contains many specifics, they should not be construed as limitations of the scope of the disclosure, but rather as an exemplification of a presently preferred embodiments thereof.

Further, since numerous modifications and changes will readily occur to those skilled in the art, it is not desired to limit the present disclosure to the exact methodology shown and described, and accordingly all suitable modifications and equivalents may be resorted to while still falling within the scope and spirit of the instant disclosure.

1. A premium vodka having improved mouthfeel and smoothness, wherein said vodka is distilled from curated grains with a select variety of carefully selected olives and Extra Virgin Olive Oil.
